(19) United States
(12) Patent Application Publication
(10) Pub. No.: US 2008/0141130 A1
(43) Pub. Date: Jun. 12, 2008

(54) MULTIMEDIA SOFTWARE SYSTEM

(76) Inventors: Herman Moore, Rochester Hills, MI (US); Angela Moore, Rochester Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/853,583

(22) Filed: Sep. 11, 2007

Related U.S. Application Data
(60) Provisional application No. 60/825,203, filed on Sep. 11, 2006.

(51) Int. Cl. G06F 3/00; G06F 3/14

(52) U.S. Cl. 715/714; 715/716

(57) ABSTRACT

A multimedia software system is provided, comprising: (1) a source of subject matter; (2) a subject matter delivery system operable to deliver the subject matter to a user via multiple modes of subject matter presentation; and (3) a user interface system in operable association with the delivery system, wherein the user interface system is selectively operable to search for, access and/or display the subject matter in multiple modes of subject matter presentation. Subject matter can be provided, uploaded, downloaded, recorded, searched, accessed and/or displayed. The system can simultaneously display different types of media presentations on a single computer screen without the need for popup screens and/or the like. For example, a video presentation can play in a first screen portion, a text presentation can display in a second screen portion, and an audio presentation can play in a third screen portion, wherein the viewer can simultaneously view all of the presentations on a single screen at the same time. The online system is useful for applications such as but not limited to religious instruction, entertainment, education, industrial training, professional training, and/or the like.

### CROSS-REFERENCE TO RELATED APPLICATION

The instant application claims priority to U.S. Provisional Patent Application Ser. No. 60/825,203, filed Sep. 11, 2006, the entire specification of which is expressly incorporated herein by reference.

### FIELD OF THE INVENTION

The present invention relates generally to multimedia software systems, and more particularly to multimedia software systems, wherein various types of media can be automatically, or in response to a user command, simultaneously populated in discrete portions of a computer screen display.

### BACKGROUND OF THE INVENTION

The advent of the Internet (e.g., the World Wide Web) has led to the ability of users, such as but not limited to various religious worshippers, wherever they are physically located, to access online information about particular places of worship, including descriptions of their religious affiliation and theology, services offered, schedules of programs, and the like. This has allowed individuals who choose not to or cannot personally attend religious services to have a means for accessing information about their particular chosen place of worship.

While some of these online services allow a worshipper to view or listen to a specific and very limited set of text, audio and/or video presentations, e.g., prayers, hymns, services, sermons and the like, these sites are not organized very well, are not user friendly, do not allow the user to fully search and/or explore specific topics of interest among many different houses of worship, and generally do a poor job of facilitating the accessing of various types of information, whether it be based on text, graphics, audio, video or combinations thereof, in a easy and quick manner for the user.

Thus, it would be desirable to have new and improved multimedia software systems, such as those that enable online worship systems that overcome at least one of the aforementioned problems.

### SUMMARY OF THE INVENTION

In accordance with a first embodiment of the present invention, an online media delivery system is provided, comprising: (1) a source of subject matter; (2) a subject matter delivery system operable to deliver the subject matter to a user via multiple modes of subject matter presentation; and (3) a user interface system in operable association with the delivery system, wherein the user interface system is selectively operable to search, access, display, record, download or upload the subject matter in multiple modes of subject matter presentation, wherein the user interface system includes a first media display section and a second media display section simultaneously occupying a single window of a media display device.

In accordance with one aspect of the present invention, the source of subject matter is selected from the group consisting of a database, an electronic database, a data containment system, video files, audio files, animation files, database files, graphics files, text files, and combinations thereof.

In accordance with another aspect of the present invention, the subject matter delivery system is selected from the group consisting of a computer, computer server, a computer network, a data storage device, an optical medium, and combinations thereof.

In accordance with still another aspect of the present invention, the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

In accordance with still yet another aspect of the present invention, the presentation of multiple modes of subject matter presentation is selected from the group consisting of text, video, audio, graphics, animation, and combinations thereof.

In accordance with a further aspect of the present invention, a menu system is provided that is operably associated with the user interface system, wherein the menu system is selectively operable to directly access the source of subject matter.

In accordance with a still further aspect of the present invention, the source of subject matter is selectively operable to be automatically displayed in either the first media display section or the second media display section.

In accordance with a still yet further aspect of the present invention, the source of subject matter includes a first type of subject matter and a second type of subject matter, wherein when the first type of subject matter and the second type of subject are uploaded to the subject matter delivery system, the first type of subject matter is automatically displayed in the first media display section and the second type of subject matter is automatically displayed in the second media display section.

In accordance with an additional aspect of the present invention, either of the first media display section or the second media display section is selectively operable to display a source of subject matter selected from the group consisting of video files, audio files, animation files, database files, graphics files, text files, and combinations thereof.

In accordance with a first alternative embodiment of the present invention, an online media delivery system is provided, comprising: (1) a source of subject matter; (2) a subject matter delivery system operable to deliver the subject matter to a user via multiple modes of subject matter presentation; and (3) a user interface system in operable association with the delivery system, wherein the user interface system is selectively operable to search, access, display, record, download or upload the subject matter in multiple modes of subject matter presentation, wherein the user interface system includes a first media display section, a second media display section, and a third media display section simultaneously occupying a single window of a media display device.

In accordance with one aspect of the present invention, the source of subject matter is selected from the group consisting of a database, an electronic database, a data containment system, video files, audio files, animation files, database files, graphics files, text files, and combinations thereof.

In accordance with another aspect of the present invention, the subject matter delivery system is selected from the group consisting of a computer, computer server, a computer network, a data storage device, an optical medium, and combinations thereof.

In accordance with still another aspect of the present invention, the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

In accordance with still yet another aspect of the present invention, the presentation of multiple modes of subject matter presentation is selected from the group consisting of text, video, audio, graphics, animation, and combinations thereof.

In accordance with a further aspect of the present invention, a menu system is provided that is operably associated with the user interface system, wherein the menu system is selectively operable to directly access the source of subject matter.

In accordance with a still further aspect of the present invention, the source of subject matter is selectively operable to be automatically displayed in either the first media display section, the second media display section, or the third media display section.

In accordance with a still yet further aspect of the present invention, the source of subject matter includes a first type of subject matter, a second type of subject matter, and a third type of subject matter, wherein when the first type of subject matter, the second type of subject, and the third type of subject matter are uploaded to the subject matter delivery system, the first type of subject matter is automatically displayed in the first media display section, the second type of subject matter is automatically displayed in the second media display section, and the third type of subject matter is automatically displayed in the third media display section.

In accordance with an additional aspect of the present invention, either of the first media display section, the second media display section, or the third media display section is selectively operable to display a source of subject matter selected from the group consisting of video files, audio files, animation files, database files, graphics files, text files, and combinations thereof.

In accordance with a second alternative embodiment of the present invention, an online media delivery system is provided, comprising: (1) a source of subject matter; (2) a subject matter delivery system operable to deliver the subject matter to a user via multiple modes of subject matter presentation; and (3) a user interface system in operable association with the delivery system, wherein the user interface system is selectively operable to search, access, display, record, download or upload the subject matter in multiple modes of subject matter presentation, wherein the user interface system includes a first media display section, a second media display section, and a third media display section simultaneously occupying a single window of a media display device, wherein the source of subject matter is selectively operable to be automatically displayed in either the first media display section, the second media display section, or the third media display section, wherein the source of subject matter includes a first type of subject matter, a second type of subject matter, and a third type of subject matter, wherein when the first type of subject matter, the second type of subject, and the third type of subject matter are uploaded to the subject matter delivery system, the first type of subject matter is automatically displayed in the first media display section, the second type of subject matter is automatically displayed in the second media display section, and the third type of subject matter is automatically displayed in the third media display section.

In accordance with one aspect of the present invention, the source of subject matter is selected from the group consisting of a database, an electronic database, a data containment system, video files, audio files, animation files, database files, graphics files, text files, and combinations thereof.

In accordance with another aspect of the present invention, the subject matter delivery system is selected from the group consisting of a computer, computer server, a computer network, a data storage device, an optical medium, and combinations thereof.

In accordance with still another aspect of the present invention, the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

In accordance with yet another aspect of the present invention, the presentation of multiple modes of subject matter presentation is selected from the group consisting of text, video, audio, graphics, animation, and combinations thereof.

In accordance with still yet another aspect of the present invention, a menu system is operably associated with the user interface system, wherein the menu system is selectively operable to directly access the source of subject matter.

In accordance with a further aspect of the present invention, either of the first media display section, the second media display section, or the third media display section is selectively operable to display a source of subject matter selected from the group consisting of video files, audio files, animation files, database files, graphics files, text files, and combinations thereof.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

The present invention will become more fully understood from the detailed description and the accompanying drawings, wherein:

FIG. 1a illustrates a schematic of a flowchart illustrating the primary steps in a startup routine system for an online worship system, in accordance with a first embodiment of the present invention;

FIG. 1b illustrates a schematic of a flowchart illustrating the primary steps in a project data management system for an online worship system, in accordance with a second embodiment of the present invention;

FIG. 1c illustrates a schematic of a flowchart illustrating the primary steps in a worship online community system for an online worship system, in accordance with a third embodiment of the present invention;

FIG. 2 illustrates a screen capture of a video project login window, in accordance with a fourth embodiment of the present invention;

FIG. 3 illustrates a screen capture of a service vision graphical user interface (GUI) after the user has logged in, in accordance with a fifth embodiment of the present invention;

FIG. 4 illustrates a screen capture of a GUI and an associated about dialog window, in accordance with a sixth embodiment of the present invention;

FIG. 5 illustrates a screen capture of a GUI and an associated video project help window, in accordance with a seventh embodiment of the present invention;

FIG. 6 illustrates a screen capture of a GUI and an associated change events window, in accordance with an eighth embodiment of the present invention;

FIG. 7 illustrates a screen capture of a GUI during video recording, in accordance with a ninth embodiment of the present invention;

FIG. 8 illustrates a screen capture of a GUI during video playback, in accordance with a tenth embodiment of the present invention;

FIG. 9 illustrates a screen capture of a video uploading window, in accordance with an eleventh embodiment of the present invention;

FIG. 10 illustrates a screen capture of a worship online community homepage, in accordance with a twelfth embodiment of the present invention;

FIG. 11 illustrates a screen capture of a worship online community homepage after a user has logged on, in accordance with a thirteenth embodiment of the present invention;

FIG. 12 illustrates a screen capture of a church search results, in accordance with a fourteenth embodiment of the present invention;

FIG. 13 illustrates a screen capture of a church site with event and video selections from play lists, in accordance with a fifteenth embodiment of the present invention;

FIG. 14 illustrates a screen capture of a church website made from a template home page, in accordance with a sixteenth embodiment of the present invention;

FIG. 15 is a screen capture of a multimedia software system main home page window, in accordance with a seventeenth embodiment of the present invention;

FIG. 16 is a screen capture of a GUI of the multimedia software system after the user has logged in, in accordance with an eighteenth embodiment of the present invention;

FIG. 17 is a screen capture of a GUI and associated content upload manager window of the multimedia software system, in accordance with a nineteenth embodiment of the present invention; and

FIG. 18 is a screen capture of a GUI and an associated information window of the multimedia software system, in accordance with a twentieth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Although the invention will be described with primary reference to an online worship system, it should be appreciated that the online system of the present invention is also useful for other applications such as but not limited to entertainment, education, industrial training, professional training, and/or the like.

While the present invention will be described with primary reference to online worship systems, it should be appreciated that the present invention can be practiced with any system of providing text, graphics, sound, or other types of media to a user, especially a user at a remote site, either in conjunction with a wired and/or wireless system, such as a computer and/or mobile device (e.g., notebook computer, personal digital assistant (PDA), portable music devices, cell phone and/or the like).

In accordance with one aspect of the present invention, a multimedia software system is provided, comprising: (1) a source of subject matter; (2) a subject matter delivery system operable to deliver the subject matter to a user via multiple modes of subject matter presentation; and (3) a user interface system in operable association with the delivery system, wherein the user interface system is selectively operable to search for, access, display, record, download, upload, and/or otherwise process the subject matter in multiple modes of subject matter presentation.

The source of the subject matter can include, without limitation, databases, electronic databases, data containment systems, and data selected from the group consisting of video files, audio files, animation files, database files, graphics files, text files, and combinations thereof.

The subject matter delivery system can include, without limitation, computers, computer servers, computer networks, data storage devices, optical, video and/or audio mediums (CD, CD-ROM, DVD, photographic cameras (e.g., digital and analog), camcorders, videotape cameras, motion film cameras, videotapes, films, still photographs, laser discs, audiotapes (e.g., digital and analog), and/or the like), transmissions of the subject matter across a wide area network, transmissions of the subject matter across a local area network, transmissions of the subject matter from one data storage device to a second data storage device, and wireless transmissions of the subject matter.

The presentation of multiple modes of subject matter presentation can include, without limitation, text, video, audio, graphics, animation, and combinations thereof.

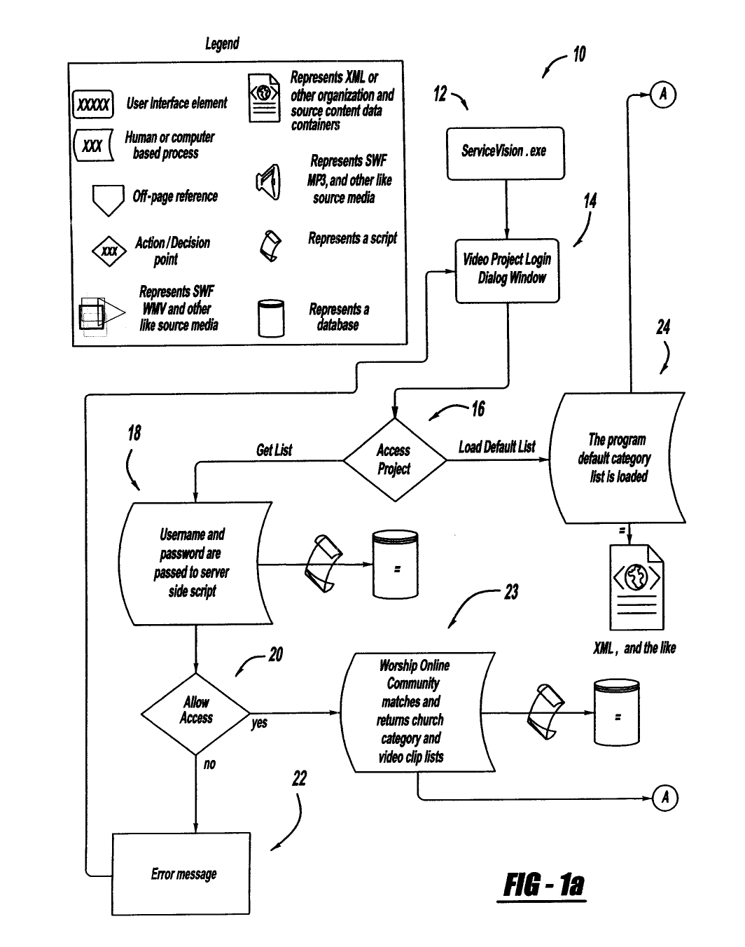

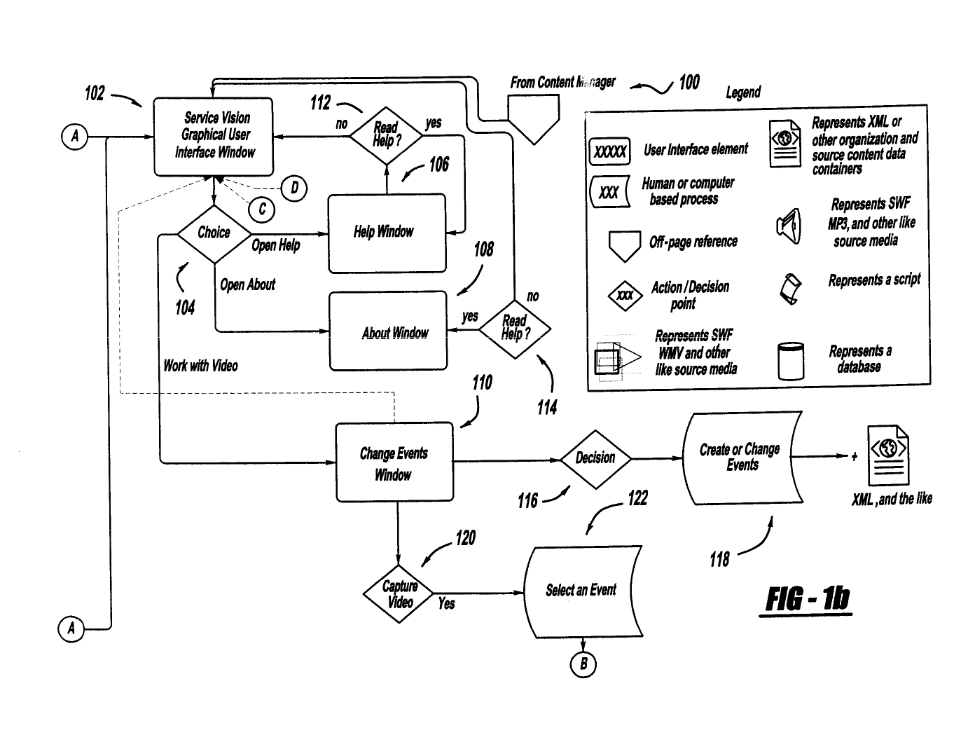

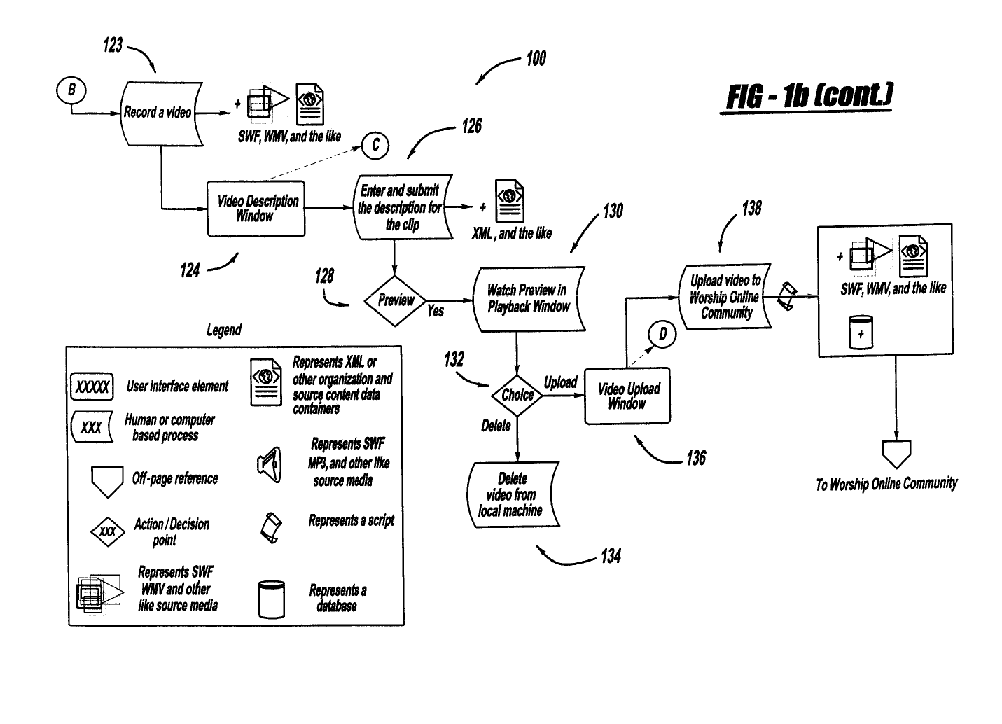

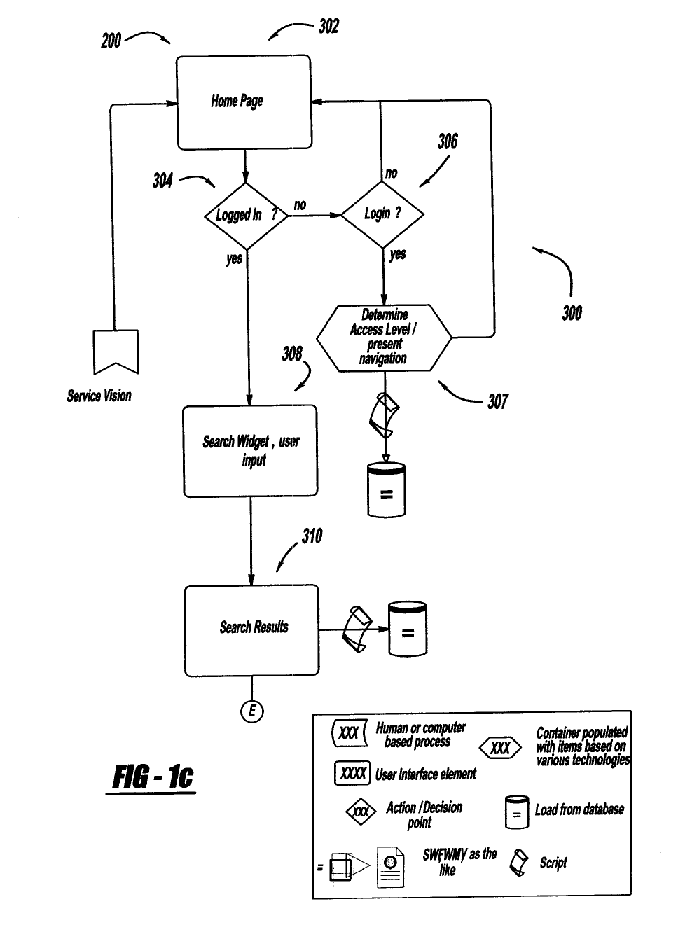

Referring to FIGS. 1a and 1b, there is generally shown illustrative schematic views of flowcharts illustrating the primary processing steps of a startup routine system 10 and a project data management system 100 for a multimedia software system 200.

The multimedia software system 200 of the present invention can be practiced in conjunction with the Internet, World Wide Web, intranets, extranets, electronic media (e.g., CD/DVD-based systems), or the like, as well as desktop, workstation, kiosk, and/or server based computer systems. By “worship,” as that term is used herein, it is meant any theological or religious based and/or related activity and/or system.

The subject matter, e.g., religious subject matter, that can be provided, searched, accessed and/or displayed can include, without limitation, any subject matter, in any form as previously described or as will be described herein, regarding or concerning any theology, religion and/or belief system, regardless of denomination, affiliation and/or reference to a particular house of worship, including subject matter and/or activities tangential thereto.

In order to fully appreciate the benefits and features of the multimedia software system 200 of the present invention, it is assumed that an individual practicing the present invention will preferably have: access to a computer (and is conversant with the basic functions thereof); an Internet service provider (“ISP”) (e.g., AOL™, NETZERO™, JUNO™, or the like) with e-mail capability; a Web browser (e.g., INTERNET EXPLORER™, NETSCAPE™, or the like); any required plug-ins (e.g., FLASH™, SHOCKWAVE™, JAVA VIRTUAL MACHINE™, or the like); and have the ability to navigate successfully to any given uniform resource locator (“URL”).

Referring specifically to the startup routine system 10, a user interface element 12 (e.g., a screen icon, a command line and/or the like) is first encountered which prompts the user to execute a software program to launch the online worship system software. In this case, the software program name is ServiceVision.exe; however, it should be appreciated that the software program name can have any other number of names.

Once the software program is launched, the user encounters user interface element, e.g., a video project login dialog window 14, which prompts the user to enter appropriate login information, e.g., a user name, project name, password, and/or the like.

At this point, a logic gate 16 is preferably reached wherein a decision is made whether to access a project or not, e.g., if a project list is to be provided to the user or a default list of projects is to be provided to the user.

If a decision is made to generate a list of projects for the user, the user name, password and/or other relevant information is passed through to a server-side script, e.g., as shown at step 18. By way of a non-limiting example, the user information can be client-directed to/from a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language).

At this point, a logic gate 20 is preferably reached wherein a decision is made whether to allow access to the user based, at least in part, on the inputted information.

If a decision is made to deny access to the user, the user encounters still another user interface element, e.g., an error message window 22, e.g., which informs the user that access is being denied for any number of reasons, and directs the user back to the video project login dialog window 14, which again prompts the user to enter appropriate login information, e.g., a user name, project name, password, and/or the like. If the decision is made to grant access to the user, the worship online community system (also referred to as the online worship community system, to be described herein) matches and returns the church category and video clip lists, e.g., as step 23, e.g., in conjunction with a database, such as but not limited to MySQL or SQL Database through a server access database script such as but not limited to PHP script or ASP via a data packaging code such as but not limited to XML.

Alternatively, if a decision is made to generate or load a default list of projects for the user, the program default category list is loaded, e.g., as shown at step 24. By way of a non-limiting example, the default list of projects can be associated with an XML or other organization and source content data container.

Regardless of which route is taken, the user is eventually directed to the project data management system 100, specifically to the user interface element, e.g., service vision graphical user interface window 102. By “service vision,” as that phrase is used herein, it is meant to include any system for practicing and/or demonstrating the present invention.

At this point, a logic gate 104 is preferably reached wherein a decision is made whether to open a help window 106, an about window 108, and/or a change events window 110.

If a decision is made to open the help window 106, the user is directed to the help window 106, wherein logic gate 112 is preferably reached wherein a decision is made whether to read the help window 106 contents. If the answer is in the affirmative, the user is directed back to the help window 106. If the answer is in the negative, the user is directed back to the service vision graphical user interface window 102.

If a decision is made to open the about window 108, the user is directed to the about window 108, wherein logic gate 114 is preferably reached wherein a decision is made whether to read the about window 108 contents. If the answer is in the affirmative, the user is directed back to the about window 108. If the answer is in the negative, the user is directed back to the service vision graphical user interface window 102.

If a decision is made to open the change events window 110, the user is directed to the change events window 110, wherein logic gate 116 is preferably reached wherein a decision is made whether to create or change events, e.g., as shown at step 118. By way of a non-limiting example, the “create or change events” step can be associated with an XML or other organization and source content data container. The change events window 110 preferably includes an option for the user to directly navigate back to the service vision graphical user interface window 102 (e.g., by clicking on a link).

Alternatively, a logic gate 120 is preferably reached wherein a decision is made whether to capture video (although any other type of subject matter medium could be used in conjunction with the present invention such as but not limited to text, graphics, audio, and/or the like). If the answer is in the affirmative, the user is directed to select an event, e.g., at step 122. The user is then directed to record a video event, e.g., at step 123, e.g., via SWF, WMV and/or the like source media, e.g., in conjunction with an XML or other organization and source content data container.

At this point, the user is directed to a video description window 124, e.g., wherein the recorded video can be described for reference/cataloging/indexing purposes. The video description window 124 preferably includes an option for the user to directly navigate back to the service vision graphical user interface window 102 (e.g., by clicking on a link).

At this point, the user is prompted to enter and submit the description for the video clip, e.g., at step 126. By way of a non-limiting example, the “enter and submit the description for the video clip” step can be associated with an XML or other organization and source content data container.

At this point, a logic gate 128 is preferably reached wherein a decision is made whether to preview the video clip. If the answer is in the affirmative, the user watches a preview in a playback window, e.g., at step 130.

At this point, a logic gate 132 is preferably reached wherein a decision is made whether to upload or delete the video clip. If the answer is in the negative, the video clip is deleted from the local machine, e.g., at step 134. If the answer is in the affirmative, the video is uploaded, wherein the user is directed to a video upload window 136. The video upload window 136 preferably includes an option for the user to directly navigate back to the service vision graphical user interface window 102 (e.g., by clicking on a link).

The user is then directed to upload the video to the worship online community, e.g., at step 138, e.g., in conjunction with a database, such as but not limited to MySQL or SQL Database through a server access database script such as but not limited to PHP script or ASP via a data packaging code such as but not limited to XML, as well as via SWF, WMV and/or the like source media, e.g., in conjunction with an XML or other organization and source content data container. By “online worship community,” or “worship online community,” as those phrases are used herein, it is meant any individual or organization that can access, practice, or otherwise interact with the online worship system of the present invention.

Referring to FIG. 1c, there is generally shown an illustrative schematic view of a flowchart illustrating the primary processing steps of a worship online community system 300 for a multimedia software system 200.

Referring specifically to the worship online community system 300, a user interface element 302 (e.g., a home page and/or the like) is first encountered which lets the user know that he or she has arrived at the home page of the worship online community system 300.

At this point, a logic gate 304 is preferably reached wherein a decision is made whether the user is logged in or not. If the answer is in the negative, a logic gate 306 is preferably reached wherein a login event has occurred or not. If the answer is in the negative, the user is directed back to the home page 302. If the answer is in the affirmative, a determination is then made regarding the access level/present navigation of the user, e.g., at step 307, e.g., in conjunction with a database, such as but not limited to MySQL or SQL Database through a server access database script such as but not limited to PHP script or ASP via a data packaging code such as but not limited to XML.

If the answer is in the affirmative to logic gate 304, the user is directed to a search/user input window 308, which enables the user to search the contents of the worship online community system 300, or any other affiliated system. The search results are then displayed in a search results window 310, e.g., in conjunction with a database, such as but not limited to MySQL or SQL Database through a server access database script such as but not limited to PHP script or ASP via a data packaging code such as but not limited to XML.

At this point, a logic gate 311 is preferably reached wherein a decision is made whether to launch a player or to launch a church website. By “church,” as that term is used herein it is meant any house of worship, whether physical or virtual, and can include churches, synagogues, temples, mosques, shrines, and/or the like.

If the decision is to launch a church website, the user is directed to a church website window 312, which allows the user to then view a particular church's website and content contained thereon. This is particularly advantageous if the user is attempting to view his or her own church's particular subject matter content.

If the decision is made to launch a player, the user is directed to a player window 314. At this point, a determination is made regarding what events are available (e.g., sermons, prayers, ceremonies and/or the like), e.g., at step 315, e.g., in conjunction with a database, such as but not limited to MySQL or SQL Database through a server access database script such as but not limited to PHP script or ASP via a data packaging code such as but not limited to XML.

The user is then able to select an event from the event list, e.g., at step 316, whereupon a determination of the available clips is made, e.g., at step 318, e.g., in conjunction with a database, such as but not limited to MySQL or SQL Database through a server access database script such as but not limited to PHP script or ASP via a data packaging code such as but not limited to XML.

The user is then able to select an item from the play list, e.g., at step 320, e.g., in conjunction with a server access database script such as but not limited to PHP script or ASP via a data packaging code such as but not limited to XML, as well as via SWF, WMV and/or the like source media, e.g., in conjunction with an XML or other organization and source content data container.

The video is then played for the user, e.g., at step 321. Alternatively, the user could have also entered a command from the player window 314, if he or she knew which clip was to be played.

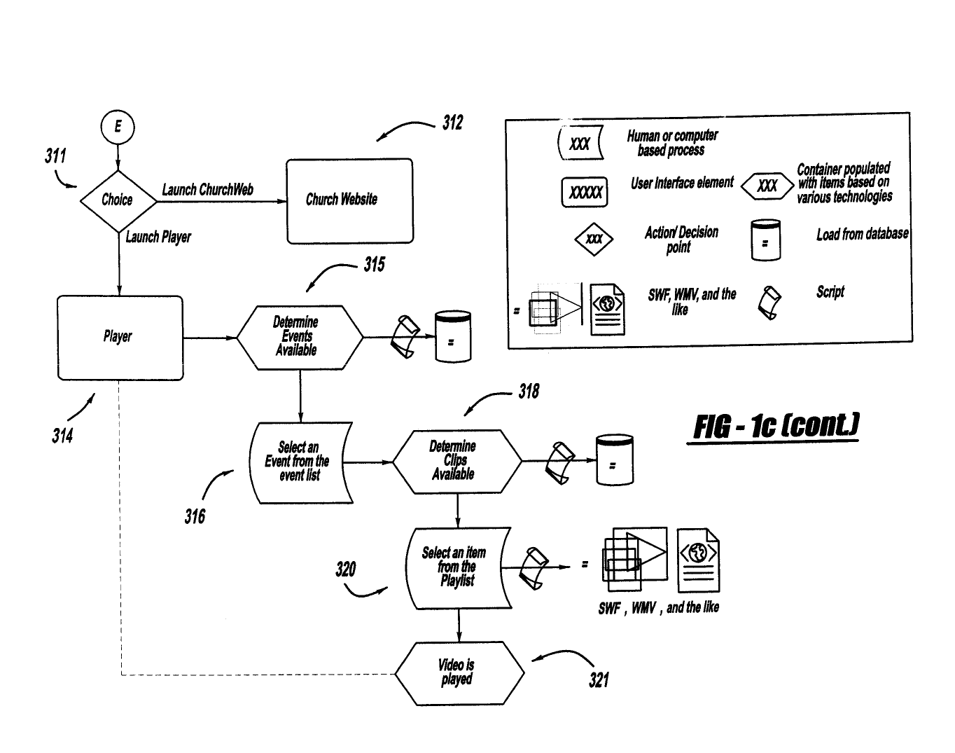

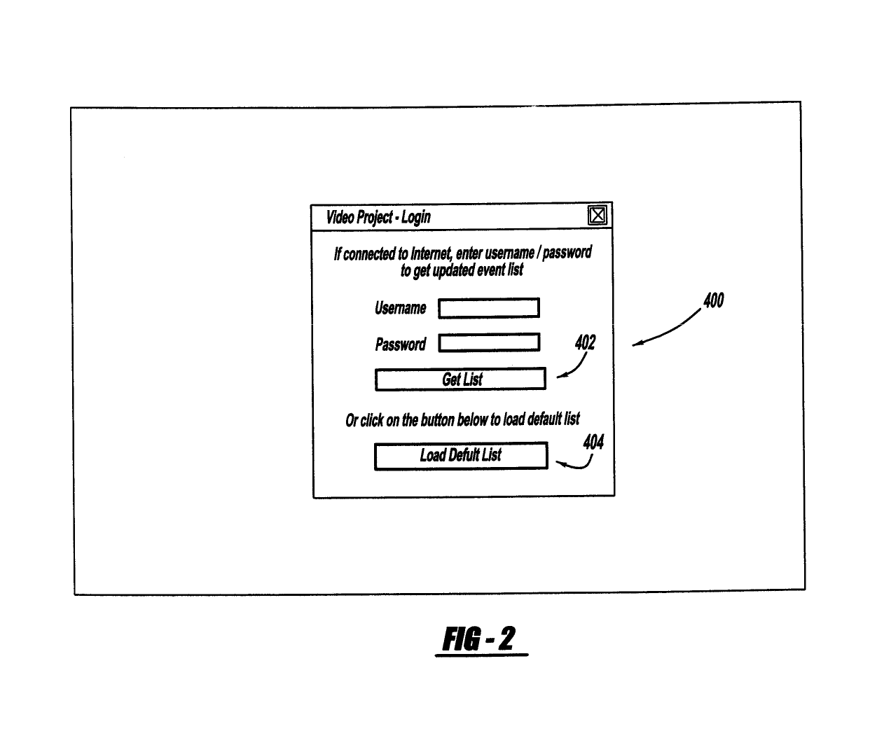

In order to demonstrate the various features of the present invention, as well as the user-friendliness of the present invention, several screen captures are presented in FIGS. 2-14, the descriptions of which are presented below.

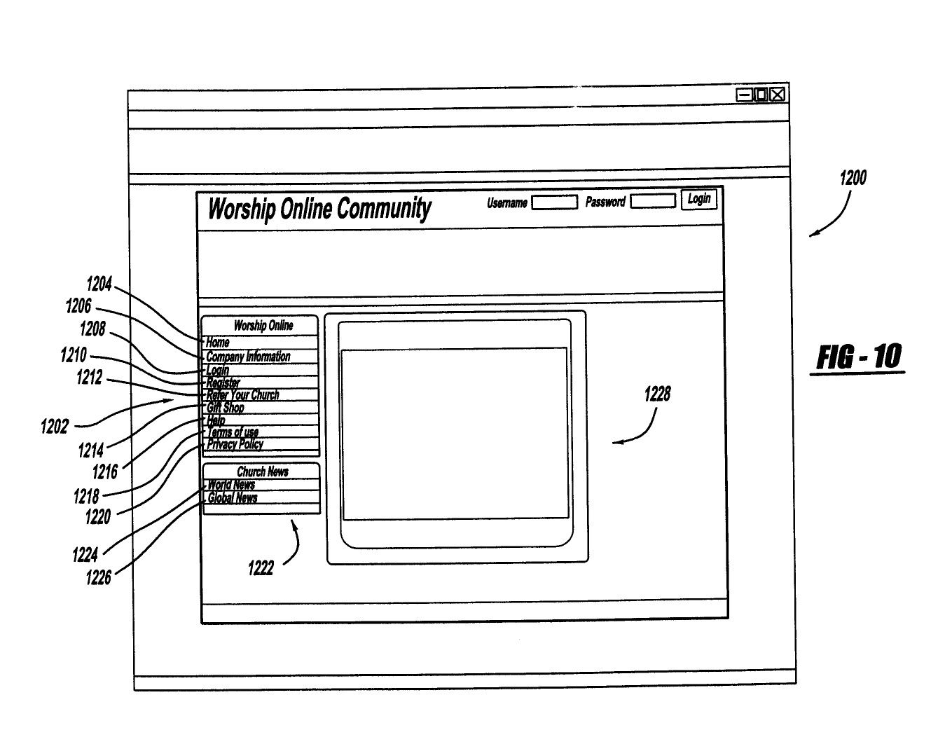

FIGS. 2-9 generally relate to the project data management system of the online worship system of the present invention. These screen captures generally represent what an authorized user and/or administrator would view and interact with, versus the screen captures for FIGS. 10-14, which are primarily directed towards end-users. It should be noted that although the present invention is primarily directed to online systems, the foregoing figures have mostly omitted any indicia of an actual online environment, such as but not limited to the ISP menu/status bars and/or the like for purposes of clarity and illustration. Additionally, although the following figures are primarily directed to the steps of a video processing system, it should be appreciated that the present invention can be practiced with any type of information format, including non-video sources, such as but not limited to audio, text, graphics, films, photographs, and/or the like, whether in digital and/or analog format.

For the following description, it is assumed that the user or end-user, as the case may be, has successfully navigated to the appropriate URL (i.e., website), through whatever equipment and/or resources are available, where the online worship system can be found.

Referring to FIG. 2, there is shown a screen capture of a video project login window 400, wherein the user name and password information of the user are requested. This is to protect the system of the present invention from unauthorized use by individuals and/or organizations. Once the requested information is provided, the user can then click on a “get list” button 402 (e.g., to retrieve subject matter the user previously set up) or a “load default list” button 404 (e.g., to retrieve all available subject matter). Optionally, the associated computer would inquire of the user whether there was a recording device (e.g., a videotape camera and/or the like) present or operably associated with the computer (e.g., via a suitable connection, such as video/audio cable, USB cable and/or the like). While the recording device would be necessary for the user to record an upcoming event (e.g., a sermon, speech or presentation about to be delivered and/or the like), the present invention can also function without any recording devices associated therewith (e.g., with only previously recorded or archived subject matter).

Referring to FIG. 3, there is shown a screen capture of a service vision graphical user interface (GUI) 500, i.e., an illustrative GUI that a user could interact with to either create, process or view subject matter of a religious nature or otherwise. In this view, a main video viewer screen 502, a preview video screen 504, and a playback video screen 506 are provided. It is important to note that all of the video screens 502, 504, 506, respectively, are displayed in a single window of the video display device (e.g., a computer monitor, television, and/or the like). That is, none of the screens 502, 504, 506, respectively, are pop-ups, requiring the user to minimize and/or maximize each of the video screens 502, 504, 506, respectively, in order to view the subject matter associated with each one. Additionally, it should be noted that the system of the present invention can be configured such that when the user “logs in,” the user can be directed to a particular screen of his/her choice (e.g., a shortcut can be created).

A main menu list 508 is provided to the left of the main video viewer screen 502, as well as additional menu lists 510, 512, respectively, to either side of the main video viewer screen 502. The main video viewer screen 502 includes a screen portion 502a, date indicator 502b, a time indicator 502c, an up arrow 502d, a down arrow 502e, and a refresh list button 502f. The preview video screen 504 includes a screen portion 504a, a current date indicator 504b, a current time indicator 504c, a record button 504d, and a stop button 504e. The playback video screen 506 includes a screen portion 506a, a date indicator 506b, a time indicator 506c, and a length indicator 506d. The record button 504d and the stop button 504e can be shared with the playback video screen 506. The main menu list 508 includes various links or buttons including a prayer button 508a, a sermon button 508b, a hymn button 508c, a special events button 508d, a scripture reading button 508e, an announcement button 508f, and several other buttons 508g, 508h, 508i, and 508j, respectively, for future system expandability. Up and down scroll arrows 508k, 5081, respectively, are provided for scrolling through the various buttons on the main menu list 508. Menu list 510 includes a change events button 510a that allows the user to change the events listed in the main menu list 508. Menu list 512 includes a files button 512a, a help button 512b, and an about button 512c. Again, all of the respective menu lists and navigation bars are displayed in a single screen of the video display device (e.g., a computer monitor, television, and/or the like), along with the video screens 502, 504, 506, respectively.

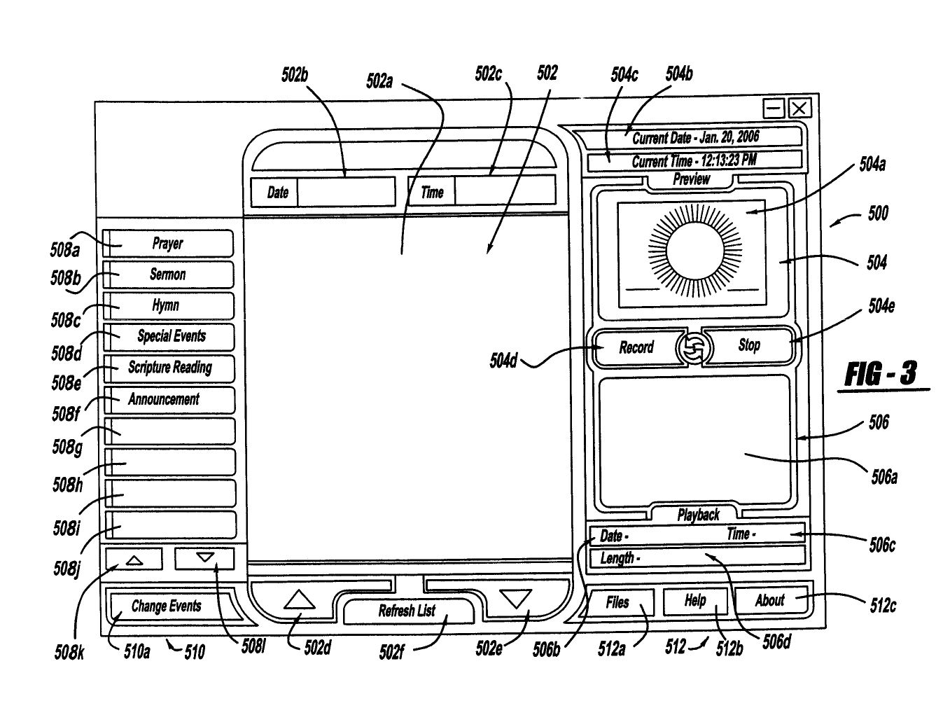

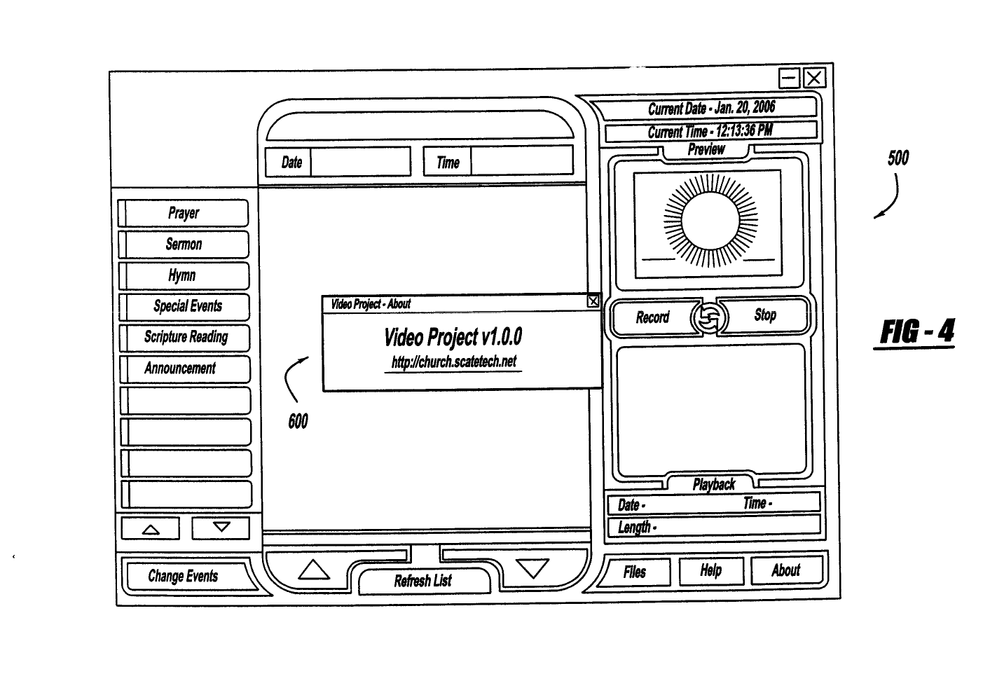

Referring to FIG. 4, there is shown a screen capture of the GUI 500 depicted in FIG. 3 and an associated about dialog window 600. The about window 600 can include information regarding a particular video project, e.g., the name of the video project, as well as other information, e.g., such as a website URL associated with the video project. In this manner, subject matter can be easily organized for later use or processing by other authorized users.

Referring to FIG. 5, there is shown a screen capture of the GUI 500 depicted in FIG. 3 and an associated video project help window 700. The help window 700 can include information regarding video recording, video playback, as well as other topics. The help window 700 is particularly helpful to those individuals that do not have extensive experience with computers and/or video recording and/the like.

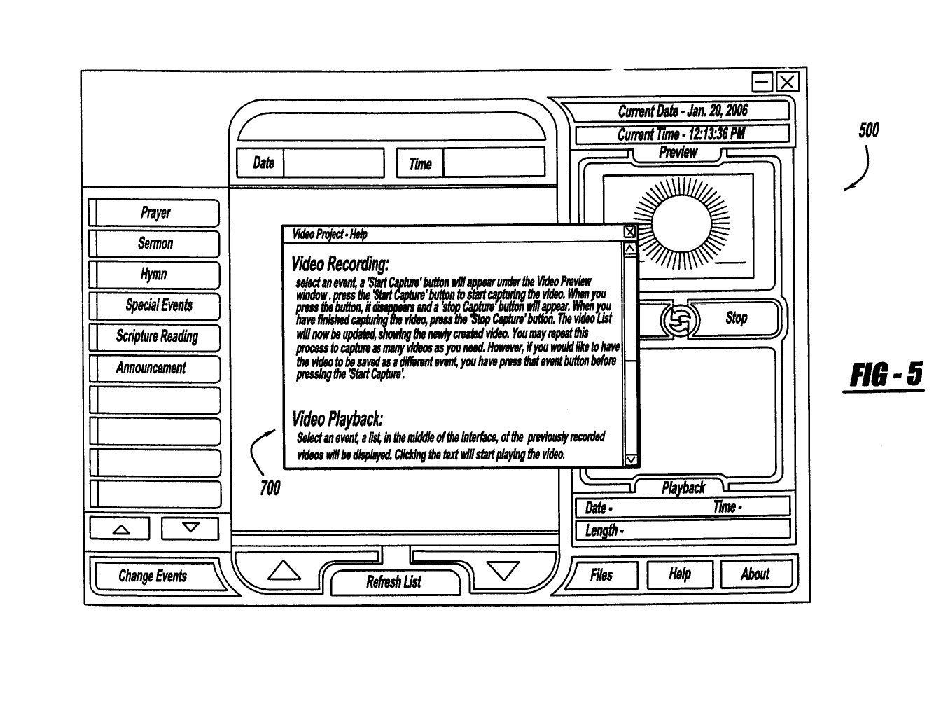

Referring to FIG. 6, there is shown a screen capture of the GUI 500 depicted in FIG. 3 and an associated change events window 800. The change events window 800 allows the user to either add, remove, and/or edit available events (e.g., video clips and/or the like) through a menu list 802 and/or current events (e.g., video clips and/or the like) through a menu list 804. An add event button 806 is shown below the respective menu lists to add new subject matter to the subject matter database. These features shown in this view are particularly helpful for quickly and easily culling and/or updating the subject matter database, including but not limited to the video clip listing.

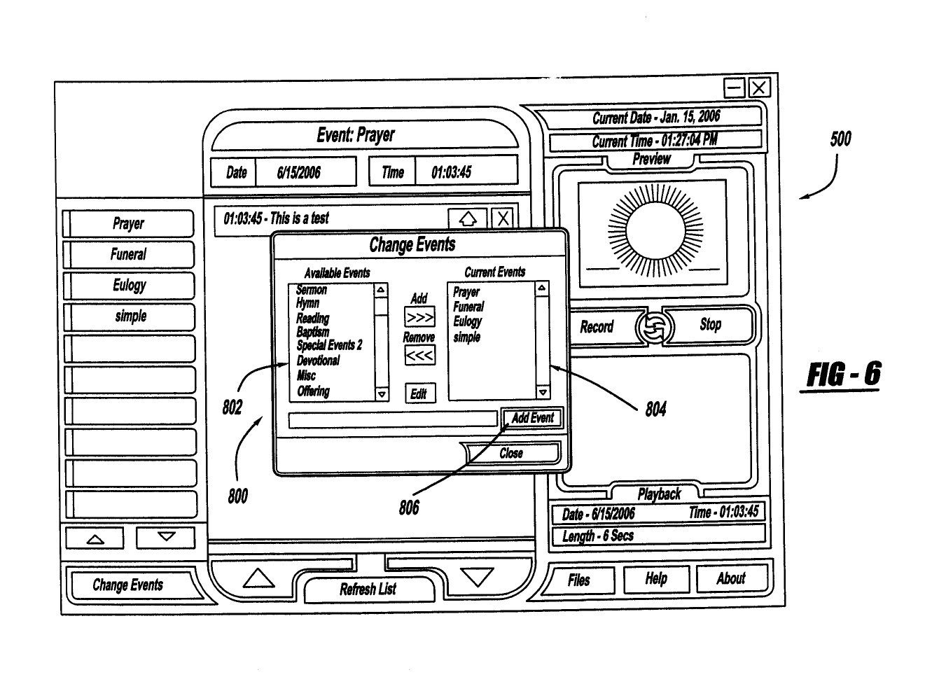

Referring to FIG. 7, there is shown a screen capture of the GUI 500 depicted in FIG. 3 during video recording, as evidenced by the record message 900. This alerts the user that a record event is taking place. This assumes that a recording device is operably associated with the user's computer. By way of a non-limiting example, the video that is being recorded could be displayed on the preview screen 902. Additionally, the record button 904 could be “lit” or “colored,” thus alerting the viewer that video was being recorded.

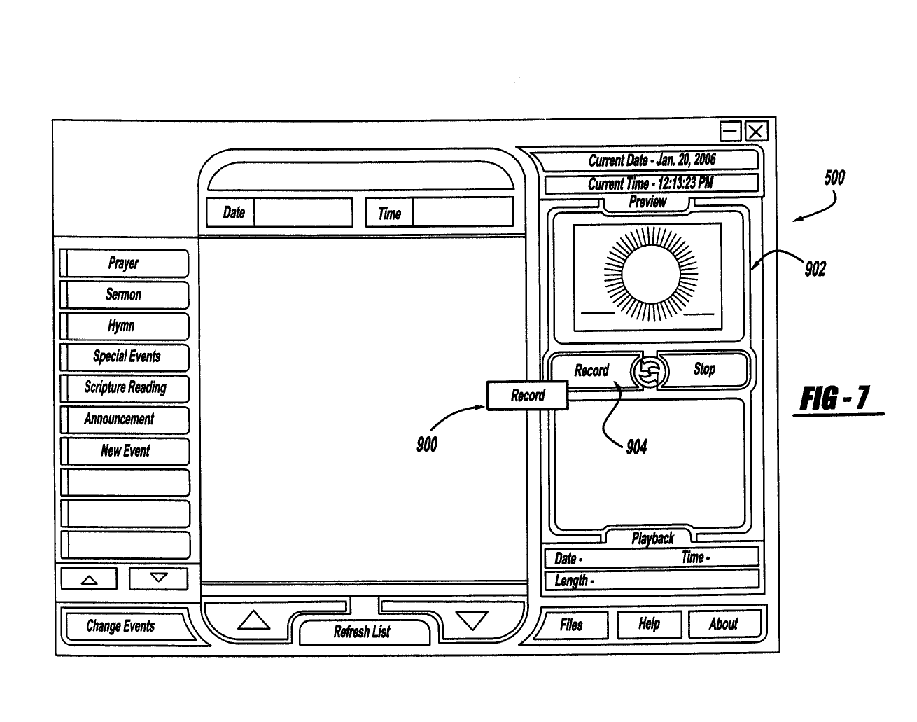

Referring to FIG. 8, there is shown a screen capture of the GUI 500 depicted in FIG. 3 during video playback, as evidenced by the video being played in the playback screen 1000. In this manner, the user can view what he or she has recorded. As previously noted, pertinent information such as, but not limited to, date, time, and length of the video clip can be displayed, e.g., below the playback screen 1000. Additionally, the name of the video clip could be displayed in video screen 502.

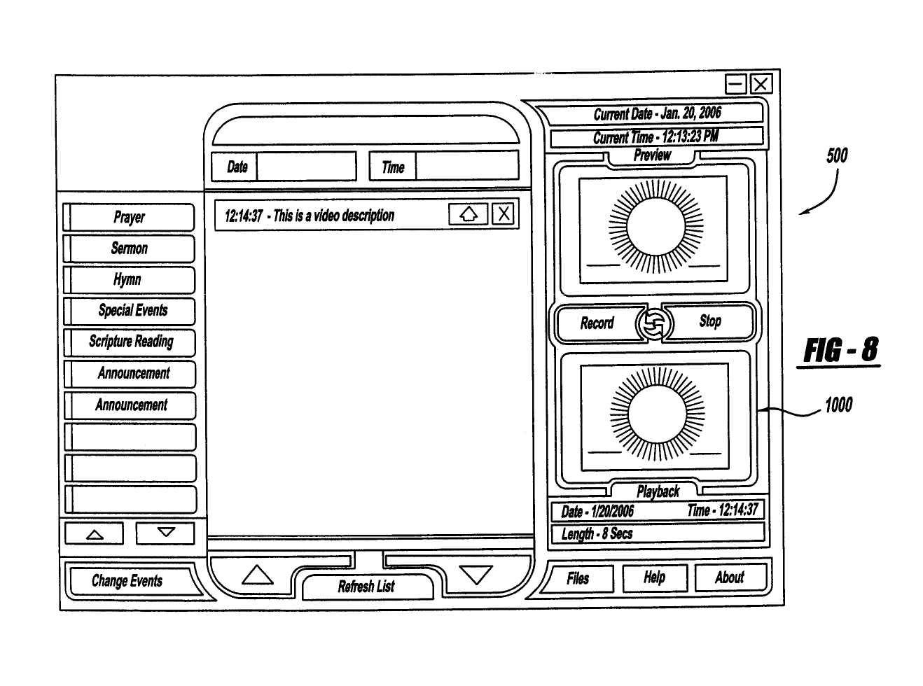

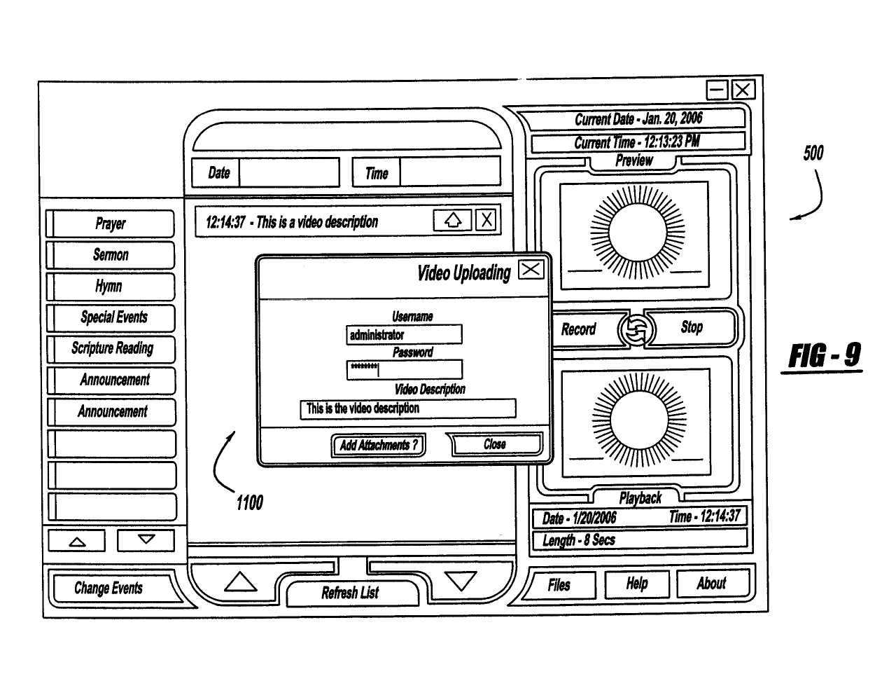

Referring to FIG. 9, there is shown a screen capture of a video uploading window 1100, e.g., in conjunction with the GUI 500 depicted in FIG. 3. By way of a non-limiting example, the video uploading window 1100 can request information from the user, such as but not limited to username, password, a description of the video clip, and/or the like. It should be appreciated that other types of files can be uploaded other than just video files, and the phrase “video uploading window” is for illustrative purposes only.

The video clip can then be uploaded, e.g., to a server or other information storage system. In this manner, any other user participating in the online worship system of the present invention can view the video clip. It should also be appreciated that any other type or medium of information can be similarly uploaded to the online worship system of the present invention, such as audio files, text files, graphics files, and/or the like.

Additionally, the present invention provides for the simultaneous uploading of additional files, regardless of their medium (e.g., video, graphics, text, audio, and/or the like), rather than having to sequentially upload files as is conventionally done. That is, the user, after designating a first file for upload (e.g., a video file) can then request additional files be uploaded simultaneously, e.g., by clicking on the “add attachment?” button of the video uploading window 1100. The user can then designate several files to be uploaded simultaneously, each potentially consisting of separate file formats (e.g., video, graphics, text, audio, and/or the like). The simultaneously uploaded files would then be “linked,” i.e., they would automatically populate specific media display sections of the window or screen of the display device (e.g., the computer screen, television, and/or the like), as will be described in more detail herein. In this manner, the user does not have to tediously and laboriously program any software code to link a multitude of files to simultaneously populate a media display section of the window or screen of the display device (e.g., the computer screen, television, and/or the like).

As previously noted, the uploaded video clip or file could be designated to display, e.g., automatically, in a particular media display section of the window or screen of the display device (e.g., the computer screen, television, and/or the like). That is, if the video clip or file is played, it will automatically display in a particular media display section of the window or screen of the display device that has been designated for video-based media, and so forth for any additional related files, whether they also be video files, or graphics, text, audio, and/or the like.

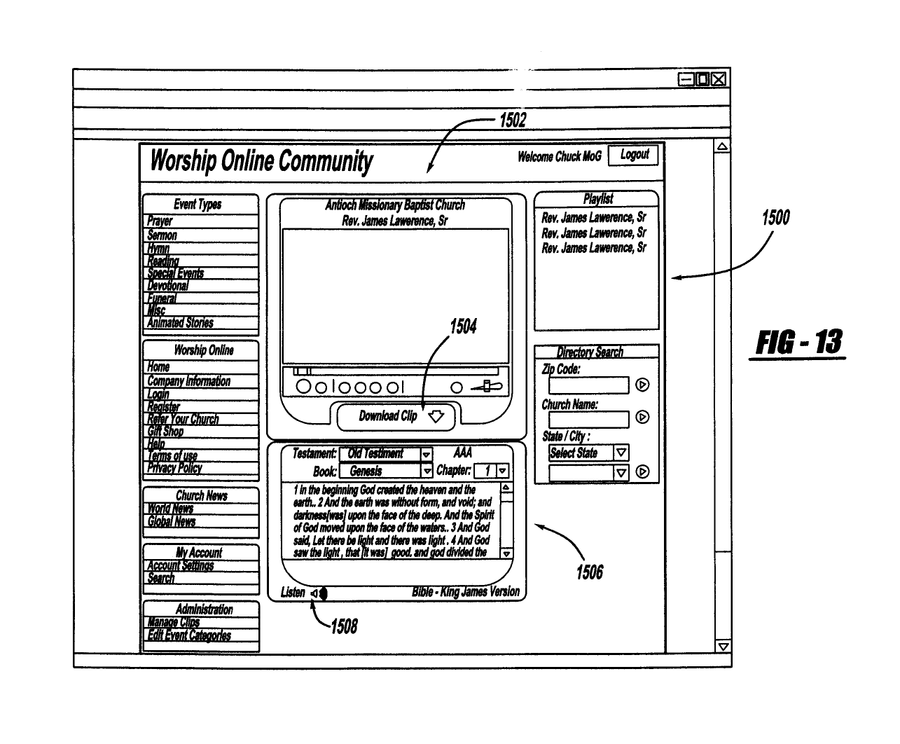

Additionally, other subject matter files can be uploaded, e.g., simultaneously or sequentially, in connection with the video clip or file. For example, one or more text files that correspond to the video clip can also uploaded to the subject matter database. In that case, when the video clip is played, any associated text files become available and/or are displayed, e.g., automatically, in another particular media display section of the window or screen of the display device that has been designated for text-based media. Furthermore, one or more audio files that correspond to either the video clip or text file can also uploaded to the subject matter database. In that case, when the video clip or text file is displayed and/or played, any associated audio files become available and/or are displayed, e.g., automatically, in still another particular media display section of the window or screen of the display device that has been designated for audio-based media. It should be appreciated that any number of different types of subject matter files can be uploaded, designated, and/or displayed on a single window or screen of the display device without the need for pop-up screens to display each type of the relevant subject matter. This feature of the present invention will become more apparent with reference to the illustrative example set forth in FIG. 13.

FIGS. 10-14 generally relate to the worship online community system of the online worship system of the present invention. These screen captures generally represent what an end-user would view and interact with, versus the screen captures for FIGS. 2-9.

Referring to FIG. 10, there is shown a screen capture of a worship online community homepage 1200. The homepage includes a worship online menu 1202, which includes various links such as home 1204, company information 1206, login 1208, register 1210, refer your church 1212, gift shop 1214, help 1216, terms of use 1218, privacy policy 1220, and/or the like. A church news menu 1222 includes links to world news 1224, global news 1226, and/or the like. A viewer screen 1228 is provided for viewing and/or listening to various informational content files, such as video clips, audio clips, text clips, and/or the like, e.g., after the end-user has logged in. Thus, an end-user can simply click on an appropriate link and be directly connected with the requested information, versus having to search through countless databases and/or search engines for the desired information. Administration-related links are not displayed in this view, as the end-user is not an administrator.

Furthermore, one user can e-mail or otherwise transmit web links or other information to another user in order to enable the other user to access the various media located or created by the first user. Of course, some or all of the access to the various media can be password protected, particularly if the media is of a sensitive nature.

By way of a non-limiting example, one user may assemble a video, text, and sound file presentation on a particular topic that may of interest to another user. The first user would save the presentation at a particular URL (with access thereto being password protected) and then e-mail the other user the web link along with an optional password to access the particular webpage. The other user could then view all of the same media as the first user, and if the other user was authorized, then modify the presentation and pass it on to still another user. In this manner, the system of the present invention provides a collaborative tool for allowing many different people being remote from one another to view the same material and have the opportunity to modify it without having to all be in the same location at the same time.

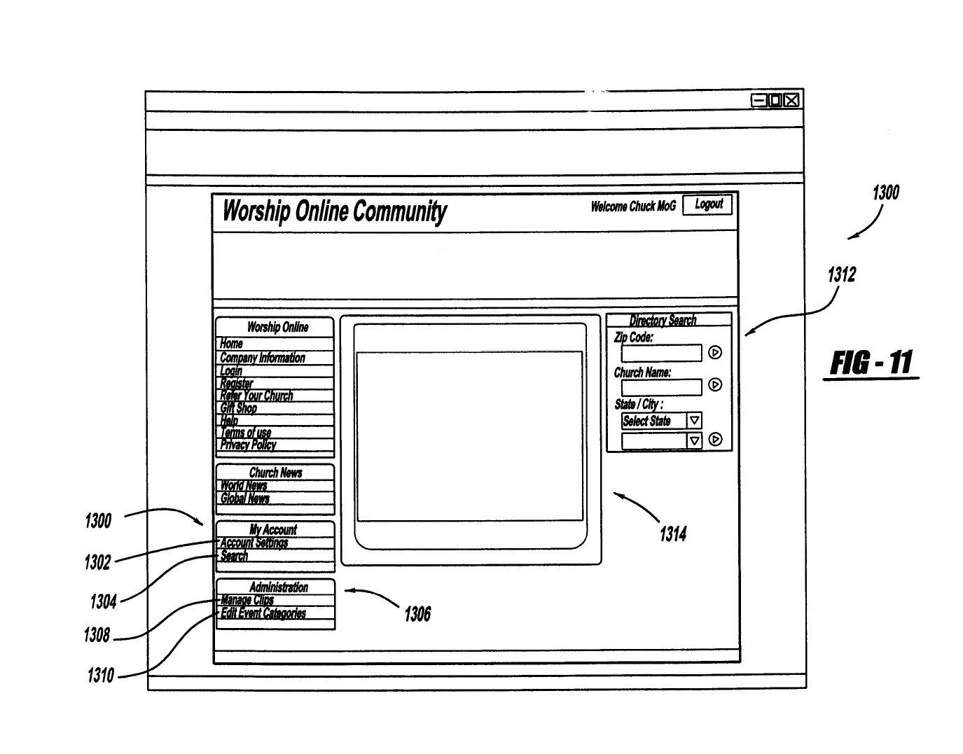

Referring to FIG. 11, there is shown a screen capture of the worship online community homepage 1300 depicted in FIG. 10 after the end-user has logged on. In this view, additional menus and/or features are provided to the end-user, such as but not limited to a my account menu 1300 (including links to account settings 1302, search 1304 and/or the like), an administration menu 1306 (including links to manage clips 1308, edit event categories 1310, and/or the like) and a directory search feature 1312, which allows searching by zip code, church name, city, state, and/or the like. It should be noted that the administration-related links are displayed in this view, as the end-user is an administrator that correctly logged in. In this manner, the end-user can search for, organize, and view information that is important to him or her. Additionally, a viewer screen 1314 is provided for viewing various event and content files.

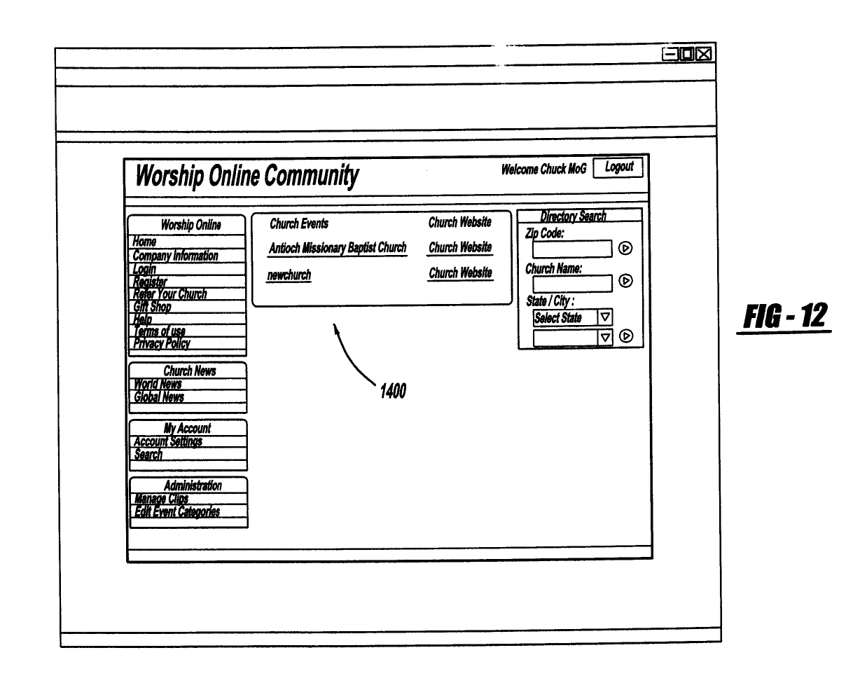

Referring to FIG. 12, there is shown a screen capture of a church search result 1400, which lists the results of the search, including links to specific churches, religious news, church websites, and/or the like. It should be noted that only links to churches that have been uploaded to the subject matter database will be displayed. Thus, an end-user can quickly locate a specific church and/or religious information, amongst a vast amount of uploaded or stored information, in an instant.

Referring to FIG. 13, there is shown a screen capture of a church website with event and video selections from play lists 1500. In this view, a first media display section, e.g., the viewer screen 1502, can play, e.g., automatically, a video selection and give the end-user the option of downloading the video clip by pressing the download button 1504. It should be noted that all uploaded video files can be designated to populate, e.g., automatically, a play list so as to alert the end-user of the choices available to him or her with respect to video clips.

Additionally, a second media display section, e.g., a supplemental viewer 1506, can simultaneously display, e.g., automatically, text information (e.g., a scripture selection, a hymn passage, and/or the like) that is, for example, relevant to the video clip or corresponds to the video clip. The supplemental viewer 1506 also allows the end-user to search for and/or scroll through a particular set of scripture to find a desired passage and/or the like. It should be noted that all uploaded text files can be designated to populate, e.g., automatically, a scrolling text list so as to alert the end-user of the choices available to him or her with respect to text files. It should be appreciated that both the viewer screen 1502 and the supplemental viewer screen 1506 are displayed in the same window or screen of the media display device (e.g., a computer screen, television, and/or the like).

Furthermore, a third media display section, e.g., an audio player 1508, can be provided to play, e.g., automatically, an audio file (e.g., a passage corresponding to the video and/or text files(s)) for an end-user who cannot see or read well or otherwise wishes to listen to the text being recited or a supplemental audio track that does not track the video and/or text file. Thus, by using the system of the present invention, a remotely-located end-user can be exposed to all of the informational content (and the overall religious experience) that a person actually attending a particular church service would encounter. It should be noted that all uploaded audio files can be designated to populate, e.g., automatically, a scrolling audio track list so as to alert the end-user of the choices available to him or her with respect to audio track lists. It should be appreciated that all of the viewer screen 1502, the supplemental viewer screen 1506, and the audio player 1508, are displayed in the same window or screen of the media display device (e.g., a computer screen, television, and/or the like).

Thus, an end-user can simultaneously view a video presentation, read text material related to the video presentation, and listen to audio information related to either the video or text presentations without having to juggle with or navigate through multiple pop-up screens. In this manner, all of the requested information is automatically displayed in discrete and distinct portions of the same window or screen of the media display device (e.g., a computer screen, television, and/or the like). Also, all of the relevant types of subject matter automatically are designated to go to the correct media display sections without any action or programming required by the user. As previously noted, the online system is also useful not just for online worship systems, but for other applications such as but not limited to entertainment, education, industrial training, professional training, and/or the like.

It should also be appreciated that the multimedia software system 200 can be programmed to populate the various media display sections in response to a user's query or search string. That is, the user, unsure about what subject matter they would like to view or hear, can type a search term into an input field, wherein the multimedia software system 200 can return the relevant search results in the form of text, video, audio and/or the like in the appropriate media display sections of the user's computer screen. For example, the user may wish to locate a particular church service, educational program, or cooking show that is featured in conjunction with the multimedia software system 200 of the present invention. Provided that the user can provide a minimum amount of information in his/her search strategy, the multimedia software system 200 of the present invention can locate that specific subject matter and return all of the associated text/video/audio files to the user such that they populate the appropriate media display sections of the user's computer screen. The user can then pick and choose which particular files to view, read or hear.

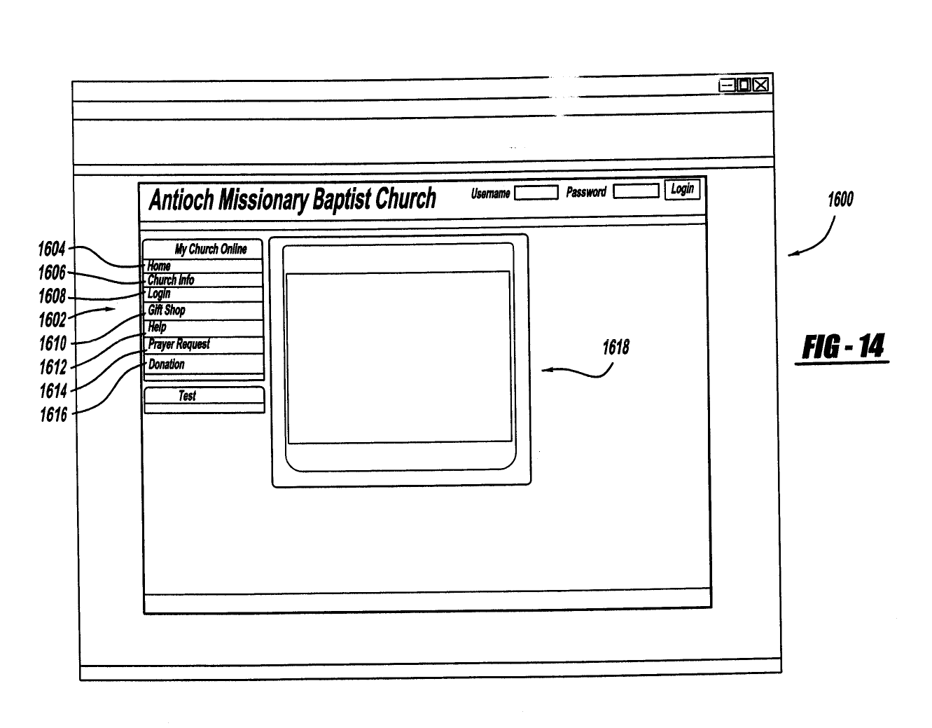

Referring to FIG. 14, there is shown a screen capture of a church website 1600 made from a template home page. In this view, a church, or any house of worship can establish their own particular website for use by their particular followers, or at least registered followers. In this manner, an end-user can go directly to his or her favorite church website, instead of having to search through a multitude of different church websites. In this view, a my church online menu 1602 is provided with links to home 1604, church info 1606, login 1608, gift shop 1610, help 1612, prayer request 1614, donation 1616, and/or the like. Additionally, a viewer screen 1618 is provided for viewing various event and content files. This feature of the church website would be especially useful to end-users who are only concerned with the affairs of their particular church and want immediate and direct access to their church website.

As previously noted, the present invention can be practiced with any number of different topics and fields of endeavor in addition to religious based topics. Additionally, as also noted, the multimedia presentations can be shared among several users, including those remote from one another. Additionally, authorized users can modify the presentations, e.g., by adding and/or deleting content from the presentations, e.g., by adding video, text, graphics, audio and/or the like. The modified presentations themselves can then be passed (e.g., via e-mail and/or posting on a website/server) among the users.

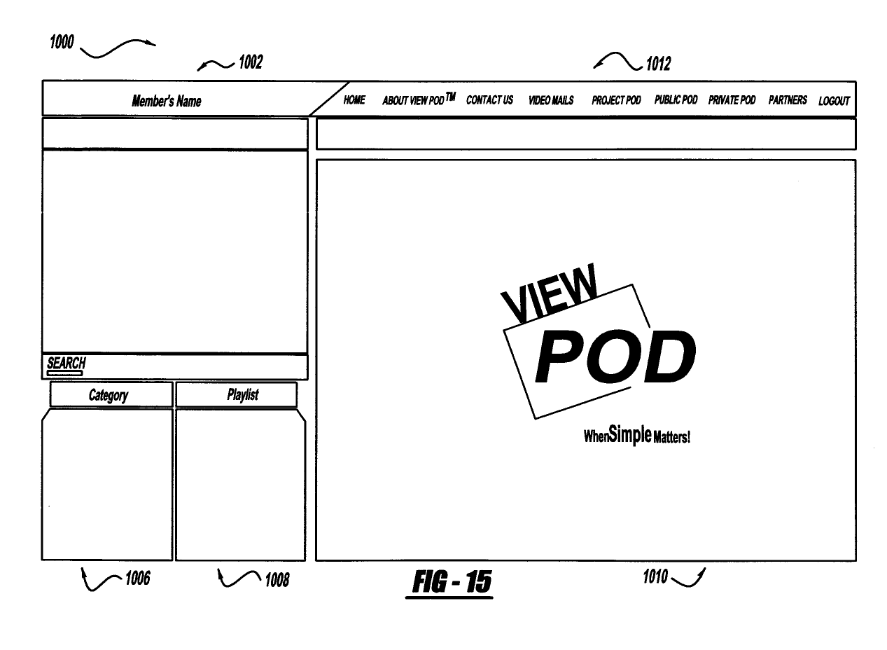

FIGS. 15-18 generally relate to the project data management system of a multimedia software system (currently referred to by the trademark VIEWPOD™) of the present invention. It should be noted that although the present invention is primarily directed to online systems, the foregoing figures have mostly omitted any indicia of an actual online environment, such as but not limited to the ISP menu/status bars and/or the like for purposes of clarity and illustration. Additionally, although the following figures are primarily directed to the steps of a multimedia processing system, it should be appreciated that the present invention can be practiced with any type of information format, such as but not limited to audio, text, graphics, films, photographs, and/or the like, whether in digital and/or analog format.

For the following description, it is assumed that the user or end-user, as the case may be, has successfully navigated to the appropriate URL (i.e., website), through whatever equipment and/or resources are available, where the project data management system of a multimedia software system can be found.

Referring to FIG. 15, there is shown a screen capture of a main home page window 1000. The display can list the user's name 1002 (see upper left hand corner of the screen), a search portion 1004 below the user's name 1002, a category portion 1006 (see lower left hand corner of the screen), a playlist portion 1008 (see lower left hand corner of the screen), and a main screen portion 1010 which includes a menu portion 1012 with such items such as “home” (to allow the user to return to the home page), “about” (tells the user about the project data management system of the multimedia software system), “contact us” (allows the user to contact the customer support staff of the project data management system of the multimedia software system), “video e-mails” (allows the user to manage video e-mails), “project” or “project POD” (allows the user to create and/or manage various projects that can later be shared among other users) “public” or “public POD” (allows the user to access projects or presentations that are open to the public), “private” or “private POD” (allows the user to access projects or presentations that are closed to the public), “partners” (allows the user to add or delete those users that are allowed or can view certain projects or presentations), and “logout” (allows the user to log off of the project data management system of the multimedia software system). The term “pod,” as used herein, is meant to refer to a group of users that are interested in the same or similar subject matter and/or who wish to view or collaborate on various projects or presentations.

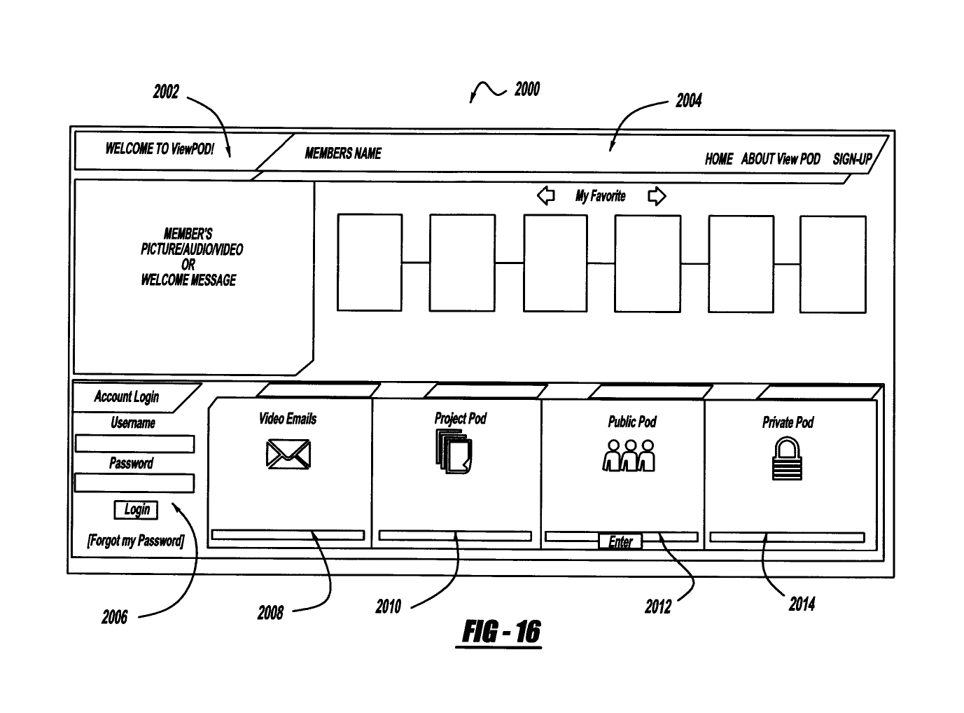

Referring to FIG. 16, there is shown a screen capture of a GUI 2000 of the multimedia software system after the user has logged in, in accordance with an eighteenth embodiment of the present invention. In this view, the user's name is displayed along the top portion of the screen. The user's picture/audio file/video file/welcome message can be automatically displayed in a first screen portion 2002. The user's “favorites” 2004 can be displayed in several discrete portions of the screen (although 6 favorites screens are shown, either less than or more than this number can be used). The favorites 2004 can consist of any type of media source, as previously described. An account login section 2006 allows other users with different passwords to log in and access the system. As previously described, the GUI 2000 can include various menu items, such as but not limited to video e-mails” 2008 (allows the user to manage video e-mails), “project” or “project POD” 2010 (allows the user to create and/or manage various projects that can later be shared among other users) “public” or public POD” 2012 (allows the user to access projects or presentations that are open to the public), and/or “private” or private POD” 2014 (allows the user to access projects or presentations that are closed to the public). The user can also add or delete other menu items, as well as customize their own “homepage” to include various menu items to display automatically.

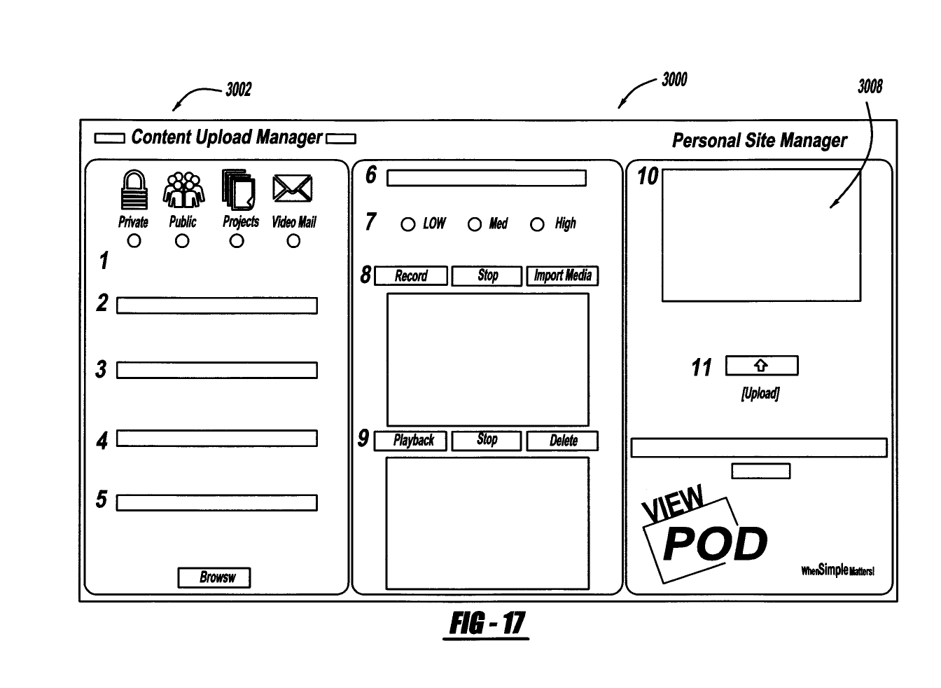

Referring to FIG. 17, there is shown a screen capture of a GUI 3000 and associated content upload manager window 3002 of the multimedia software system, in accordance with a nineteenth embodiment of the present invention. As previously noted, the user can add or upload various media files, as previously described, to enable the user to create a project or presentation that can be displayed online or transmitted to other users. By way of a non-limiting example, the user would first select which type of project or presentation is involved (e.g., private, public, project, vide mail, and/or the like). The user would then select a particular project or presentation from a drop down menu. The user would then select an appropriate category (e.g., education, professional training, religious instruction, and/or the like) to which the media is being uploaded to. The user would then create a playlist name or description for the media file that is being uploaded (e.g., to aid in searchability and/or the like). The user would then click a “browse” button or key to locate the objects to be uploaded. It should be noted that if documents, texts, graphics, and/or the like are uploaded at the same time audio and/or video files are uploaded, the audio and/or video files are automatically linked to the attached documents, texts, graphics, and/or the like.

If the user is uploading only documents, texts, graphics, and/or the like without audio and/or video files, the user would essentially be done with the uploading process (save for the actual uploading command to be sent). However, if the user is also uploading audio and/or video files, several additional steps are required. The user will be prompted to select the appropriate media device input. Then, the user will select the appropriate audio/video quality. The user can then “capture” the audio/video file, e.g., by recording, importing, and/or the like, e.g., in a discrete screen 3004 located within the window. The user can then view the captured audio/video content in another discrete screen 3006 located within the window. The user can also input notes into a notepad portion 3008 and upload them, along with any of the other media files. The user can then upload all of the selected files, which may take some time depending on the size of the files and the Internet connection speed.

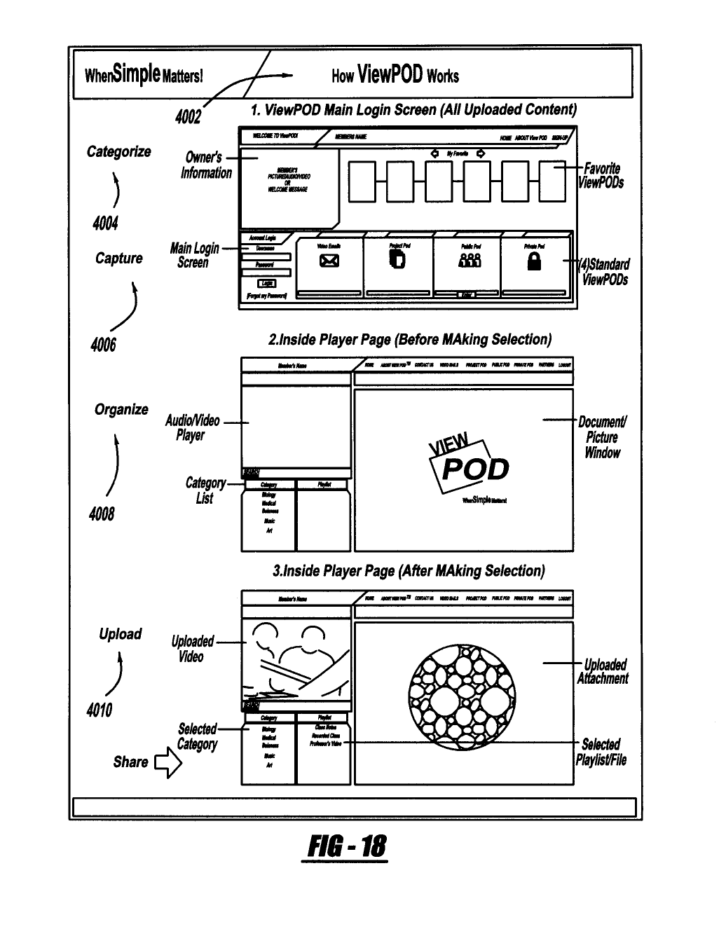

Referring to FIG. 18, there is shown a screen capture of a GUI 4000 and an associated information window 4002 of the multimedia software system, in accordance with a twentieth embodiment of the present invention. Essentially, the information window 4002 is a basic description of how the project data management system of the multimedia software system (i.e., VIEWPOD™) of the present invention functions. By way of a non-limiting example, the information window 4002 describes the categorization 4004, capturing 4006, organization 4008 and uploading 4010 functions of the system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An online media delivery system, comprising:
a source of subject matter;
a subject matter delivery system operable to deliver the subject matter to a user via multiple modes of subject matter presentation; and
a user interface system in operable association with the delivery system, wherein the user interface system is selectively operable to search, access, display, record, download or upload the subject matter in multiple modes of subject matter presentation;
wherein the user interface system includes a first media display section and a second media display section simultaneously occupying a single window of a media display device.

2. The invention according to claim 1, wherein the source of subject matter is selected from the group consisting of a database, an electronic database, a data containment system, video files, audio files, animation files, database files, graphics files, text files, and combinations thereof.

3. The invention according to claim 1, wherein the subject matter delivery system is selected from the group consisting of a computer, computer server, a computer network, a data storage device, an optical medium, and combinations thereof.

4. The invention according to claim 1, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

5. The invention according to claim 1, wherein the presentation of multiple modes of subject matter presentation is selected from the group consisting of text, video, audio, graphics, animation, and combinations thereof.

6. The invention according to claim 1, further comprising a menu system operably associated with the user interface system, wherein the menu system is selectively operable to directly access the source of subject matter.

7. The invention according to claim 1, wherein the source of subject matter is selectively operable to be automatically displayed in either the first media display section or the second media display section.

8. The invention according to claim 1, wherein the source of subject matter includes a first type of subject matter and a second type of subject matter, wherein when the first type of subject matter and the second type of subject are uploaded to the subject matter delivery system, the first type of subject matter is automatically displayed in the first media display section and the second type of subject matter is automatically displayed in the second media display section.

9. The invention according to claim 1, wherein either of the first media display section or the second media display section is selectively operable to display a source of subject matter selected from the group consisting of video files, audio files, animation files, database files, graphics files, text files, and combinations thereof.

10. An online media delivery system, comprising:
a source of subject matter;
a subject matter delivery system operable to deliver the subject matter to a user via multiple modes of subject matter presentation; and
a user interface system in operable association with the delivery system, wherein the user interface system is selectively operable to search, access, display, record, download or upload the subject matter in multiple modes of subject matter presentation;
wherein the user interface system includes a first media display section, a second media display section, and a third media display section simultaneously occupying a single window of a media display device.

11. The invention according to claim 10, wherein the source of subject matter is selected from the group consisting of a database, an electronic database, a data containment system, video files, audio files, animation files, database files, graphics files, text files, and combinations thereof.

12. The invention according to claim 10, wherein the subject matter delivery system is selected from the group consisting of a computer, computer server, a computer network, a data storage device, an optical medium, and combinations thereof.

13. The invention according to claim 10, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

14. The invention according to claim 10, wherein the presentation of multiple modes of subject matter presentation is selected from the group consisting of text, video, audio, graphics, animation, and combinations thereof.

15. The invention according to claim 10, further comprising a menu system operably associated with the user interface system, wherein the menu system is selectively operable to directly access the source of subject matter.

16. The invention according to claim 10, wherein the source of subject matter is selectively operable to be automatically displayed in either the first media display section, the second media display section, or the third media display section.

17. The invention according to claim 10, wherein the source of subject matter includes a first type of subject matter, a second type of subject matter, and a third type of subject matter, wherein when the first type of subject matter, the second type of subject, and the third type of subject matter are uploaded to the subject matter delivery system, the first type of subject matter is automatically displayed in the first media display section, the second type of subject matter is automatically displayed in the second media display section, and the third type of subject matter is automatically displayed in the third media display section.

18. The invention according to claim 10, wherein either of the first media display section, the second media display section, or the third media display section is selectively operable to display a source of subject matter selected from the group consisting of video files, audio files, animation files, database files, graphics files, text files, and combinations thereof.

19. An online media delivery system, comprising:
a source of subject matter;
a subject matter delivery system operable to deliver the subject matter to a user via multiple modes of subject matter presentation; and
a user interface system in operable association with the delivery system, wherein the user interface system is selectively operable to search, access, display, record, download or upload the subject matter in multiple modes of subject matter presentation;
wherein the user interface system includes a first media display section, a second media display section, and a third media display section simultaneously occupying a single window of a media display device;
wherein the source of subject matter is selectively operable to be automatically displayed in either the first media display section, the second media display section, or the third media display section;
wherein the source of subject matter includes a first type of subject matter, a second type of subject matter, and a third type of subject matter, wherein when the first type of subject matter, the second type of subject, and the third type of subject matter are uploaded to the subject matter delivery system, the first type of subject matter is automatically displayed in the first media display section, the second type of subject matter is automatically displayed in the second media display section, and the third type of subject matter is automatically displayed in the third media display section.

20. The invention according to claim 19, wherein the source of subject matter is selected from the group consisting of a database, an electronic database, a data containment system, video files, audio files, animation files, database files, graphics files, text files, and combinations thereof.

21. The invention according to claim 19, wherein the subject matter delivery system is selected from the group consisting of a computer, computer server, a computer network, a data storage device, an optical medium, and combinations thereof.

22. The invention according to claim 19, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

23. The invention according to claim 19, wherein the presentation of multiple modes of subject matter presentation is selected from the group consisting of text, video, audio, graphics, animation, and combinations thereof.

24. The invention according to claim 19, further comprising a menu system operably associated with the user interface system, wherein the menu system is selectively operable to directly access the source of subject matter.

25. The invention according to claim 19, wherein either of the first media display section, the second media display section, or the third media display section is selectively operable to display a source of subject matter selected from the group consisting of video files, audio files, animation files, database files, graphics files, text files, and combinations thereof.
